(19) United States
(12) Patent Application Publication
(10) Pub. No.: US 2020/0048739 A1
(43) Pub. Date: Feb. 13, 2020

(54) NICKEL ALLOY

(71) Applicant: Doncasters Limited, Burton-upon-Trent, Staffordshire (GB)

(72) Inventors: Tom SELLERS, Burton-upon-Trent, Staffordshire (GB); John SCHOFIELD, Burton-upon-Trent, Staffordshire (GB); Richard GEORGE, Burton-upon-Trent, Staffordshire (GB)

(21) Appl. No.: 16/340,648

(22) PCT Filed: Oct. 3, 2017
(86) PCT No.: PCT/GB2017/052964

§ 371 Date: Apr. 9, 2019

(30) Foreign Application Priority Data
Oct. 11, 2016 (GB) 1617227.2

(51) Int. Cl. C22C 19/05; F01D 5/28

(52) U.S. Cl. CPC C22C 19/051; F05D 2300/17; F05D 2220/40; F01D 5/28

(57) ABSTRACT

The present invention relates to nickel alloys suitable for use in high temperature environments. For example, the nickel alloys of the present invention can be used in temperatures above 800° C. The nickel alloys may be used in the automotive industry, e.g. in turbocharge turbine wheels.

This invention relates to a nickel alloy. In particular the nickel alloy is a nickel superalloy for use at high temperature (e.g. above 800° C.). The alloy of the invention may be useful in the aerospace or automotive industries, for example for use in turbocharger turbine wheels.

### BACKGROUND

As engine designers face the continuing challenge of increasing fuel efficiency, engines are being designed to burn fuel hotter and cleaner. This is true of all engine types but in particular the automotive internal combustion engine. The need to improve efficiency and the hotter fuel burn has inevitably resulted in an upward trend in the temperature of turbocharger inlet temperatures. Some new engines are being designed to operate with a turbine inlet temperature of 1050° C. and above, which exceeds the temperature capability of the ubiquitous turbocharger turbine wheel alloy, IN7130.

Other alloys are being looked at within the turbocharger industry, although these are predominantly alloys borrowed from gas turbine applications. Mar-M247 is one of the main choice alloys for new high temperature turbine wheels although it contains Ta and Hf, resulting in it being four times the price of IN7130. In an industry where keeping costs to a minimum is a key factor to winning market share, there is a great need for a bespoke low cost, high temperature capability alloy to be developed. As such, an aim of certain embodiments of the present invention is to provide a nickel alloy with comparable or improved properties to the known alloys that is cheaper.

Embodiments of the present invention also aim to provide improved high temperature tensile properties and high temperature rupture life compared to prior art alloys.

Due to the increased temperatures present in newer turbochargers. There is an increased propensity to undergo degradation of metallic components due to oxidative and corrosive wear. Therefore, embodiments of the present invention aim to provide an improved high temperature oxidation and/or corrosion properties. The prior art alloys may be of a similar cost or higher cost.

Another major factor in materials selection for turbine wheels is alloy density, as turbine wheel inertia has a large effect the rotational acceleration of a turbine wheel. A wheel cast from an alloy which has high density would be heavy and cause the turbocharger to exhibit turbo lag. Thus, an aim of certain embodiments of the present invention is to provide an alloy with a beneficial density (i.e. lower than the prior art alloys Mar-M247 and IN7130), optionally whilst also reducing the cost.

As already outlined, there is a sustained trend for operating temperatures in automotive turbocharger turbines to increase going forward. This is causing designers to look at alternative alloys to IN710 as operating temperatures exceed its capabilities. In embodiments of the current invention there is also the aim to design a high temperature alloy at the same cost as IN7130 for use in intermediate temperature (850° C.-1000° C.) turbocharger turbine wheels

### BRIEF SUMMARY OF THE DISCLOSURE

In accordance with the present inventions there is provided a nickel alloy. The nickel alloy comprises:

from 0.01 to 0.3 wt % carbon;
from 7.0 to 15.0 wt % chromium;
from 0 to 12.0 wt % cobalt;
from 3.0 to 7.0 wt % molybdenum;
from 0.1 to 9.5 wt % tungsten;
from 1.0 to 3.0 wt % niobium;
from 0 to 2.0 wt % tantalum;
from 0.5 to 2.0 wt % titanium;
from 3.5 to 7.0 wt % aluminium;
from 0 to 3.0 wt % boron;
from 0.01 to 0.1 wt % zirconium; and
either from 0.1 to 1.0 wt % hafnium or from 0.1 to 1.0 wt % vanadium;
with the balance of the composition being nickel and incidental impurities.

As stated above, nickel makes up the balance of the alloy. The nickel may optionally be present in an amount from 40 to 80 wt % of the alloy.

Within alloys of the present invention, carbon has the effect of increasing creep resistance. Carbon forms carbides with Ti, Mo, Cr, Nb, Ta and Hf which are present in Ni superalloys as primary MC carbides, secondary M6C and M23C6 carbides. Carbides have various functions and are present both as transgranular and intergranular (grain boundary) carbides. The presence of large, transgranular MC carbides has the effect of strengthening the alloy matrix as they inhibit dislocation movement. Small discontinuous grain boundary carbides act as pinning phases, which increases creep resistance. In embodiments carbon may be present in a range of from 0.05 to 0.2 wt %. Alternatively, carbon may be present in a range of from 0.7 to 0.13 wt % or 0.13 to 0.19 wt %. Preferably, carbon is present in an amount of 0.95 to 1.05 wt % (e.g. 0.1 wt %) or 0.155 to 0.165 wt % (e.g. 0.16 wt %).

Chromium increases strength and corrosion resistance. Present in the gamma matrix as a solid solution strengthener, chromium also forms a protective oxide layer, Cr₂O₃. Cr₂O₃ is particularly effective at restricting the rate of diffusion of metallic elements outward and at restricting the rate of diffusion of atmospheric elements (e.g. O, N, S) inward. In embodiments chromium is present in a range of from 7.5 to 13 wt %.

Alternatively, chromium may be present in an amount of from 12.35 wt % to 12.65 wt % or 8.05 to 8.35 wt %. Preferably, chromium is present in an amount of from 12.45 to 12.55 wt % (e.g. 12.5 wt %) or from 8.15 to 8.25 wt % (e.g. 8.2 wt %).

Nickel is the base element of the alloys of the claimed invention and forms the basis of gamma and gamma prime secondary phase precipitates in the alloy. The small lattice misfit between gamma and gamma prime is responsible for the high temperature stability of Ni alloys.

Cobalt increases strength and phase stability. The incorporation of cobalt results in a rise in the gamma prime solvus temperature. Cobalt is a solid solution strengthening element and is a gamma stabiliser, due to having a similar atomic diameter than Ni. In embodiments cobalt is optionally present in a range of from 9 to 11 wt %. Cobalt may therefore be absent from the alloy of the invention (except for any potential incidental impurities) or present in a disclosed range. Cobalt may be present in an amount of 9.8 to 10.2 wt %. Preferably, cobalt is present in an amount from 9.95 to 10.05 wt % (e.g. 10.0 wt %).

Where cobalt is present it is preferably present in an alloy of the invention that comprises hafnium. Where cobalt is present in an alloy of the invention the alloy also comprises tantalum and hafnium in amounts disclosed elsewhere herein.

In embodiments where cobalt is absent the alloy preferably comprises vanadium in amounts disclosed elsewhere herein. Alternatively, where cobalt is absent the alloy preferably does not comprise tantalum, does not comprise hafnium but does comprise vanadium.

Molybdenum and tungsten are present to increase the solid solution strength of the alloy. They also have the effect of increasing the phase stability through gamma stabilisation. It is another important component for the formation of large MC carbides.

In embodiments molybdenum is present in a range of from 3.5 to 5.5 wt %. Alternatively, molybdenum is present in an amount of from 3.8 to 4.2 wt % or 4.8 to 5.2 wt %. Preferably, molybdenum is present in an amount of from 3.95 to 4.05 wt % (e.g. 4.0 wt %) or 4.95 to 5.05 wt % (e.g. 5 wt %).

In embodiments tungsten is present in a range of from 0.1 to 1.0 wt % or 5 to 9 wt %. Alternatively, tungsten is present in an amount of from 0.3 to 0.7 wt % or 6.8 to 7.2 wt %. Preferably, tungsten is present in an amount of from 0.45 to 0.55 wt % (e.g. 0.5 wt %) or 6.95 to 7.05 wt % (e.g. 7.0 wt %).

Niobium increases strength of the alloy in both the gamma and gamma prime phases. It is a strong solid solution strengthener due to large atomic diameter. As with other components of the alloy niobium is important for the formation of large MC carbides. In embodiments niobium is present in a range of from 1.8 to 2.5 wt %. Alternatively, niobium is present in an amount of from 1.8 to 2.2 wt % or 2.0 to 2.4 wt %. Preferably, niobium is present in an amount of from 1.95 to 2.05 wt % (e.g. 2.0 wt %) or 2.15 to 2.25 wt % (e.g. 2.2 wt %).

As with niobium, tantalum is a strong solid solution strengthener due to large atomic diameter and forms large MC carbides. In embodiments tantalum is present in a range of from 0.5 to 1 wt %. Alternatively, tantalum is present in an amount of from 0.6 to 1.0 wt %. Preferably, tantalum is present in an amount of from 0.75 to 0.85 wt % (e.g. 0.8 wt %). Thus, in some embodiments, tantalum is also added to an alloy containing cobalt so that the alloy contains both tantalum and cobalt. This represents a preferred embodiment. Equally, if one of tantalum and cobalt is not present, then it is also an alternative preferred embodiment that the other is not present in that the alloy does not contain either tantalum or cobalt.

Titanium increases high temperature strength of the alloy which is important for applications of nickel superalloys (for example the automotive, e.g. turbochargers, and aerospace industries, e.g. turbines). Titanium forms gamma prime, Ni₃(Al, Ti), which is responsible for the high temperature strength of Ni base superalloys. In embodiments titanium is present in a range of from 0.6 to 1.2 wt %. Alternatively, titanium is present in an amount of from 0.6 to 1.0 wt % or 0.8 to 1.2 wt %. Preferably, titanium is present in an amount of from 0.75 to 0.85 wt % (e.g. 0.8 wt %) or 0.95 to 1.05 wt % (e.g. 1.0 wt %).

Aluminium forms gamma prime secondary phase precipitates and increases the high temperature strength of Ni superalloys. Aluminium is also responsible for anticorrosion properties by the formation of a diffusion-resistant protective oxide layer on the alloy surface. In embodiments aluminium is present in a range of from 5.0 to 7.0 wt %. Alternatively, aluminium is present in an amount of from 6.4 to 6.8 wt % or 5.3 to 5.7 wt %. Preferably, aluminium is present in an amount of from 6.55 to 6.65 wt % (e.g. 6.6 wt %) or 5.45 to 5.55 wt % (e.g. 5.5 wt %).

Boron is present to improve stress rupture life. Boron is present at grain boundaries in the form of borides, which provide the beneficial effect of improving stress rupture life. In embodiments boron is present in a range of from 0.005 to 0.02 wt %. Alternatively, boron is present in an amount of from 0.01 to 0.02 wt %. Preferably, boron is present in an amount of from 0.005 to 0.015 wt % (e.g. 0.010 wt %) or 0.0145 to 0.00155 wt % (e.g. 0.0015 wt %).

Zirconium also improves stress rupture life and it further provides the effect of a grain boundary refiner. Minor zirconium additions improve stress rupture life and inhibit the formation of cracking. In embodiments zirconium is present in a range of from 0.03 to 0.08 wt %. Alternatively, zirconium is present in an amount of from 0.05 to 0.07 wt % or 0.04 to 0.06 wt %. Preferably, zirconium is present in an amount of from 0.055 to 0.065 wt % (e.g. 0.060 wt %) or 0.045 to 0.055 wt % (e.g. 0.050 wt %).

Hafnium is a major carbide former and improves creep resistance and stress rupture properties. Hafnium also strengthens grain boundaries. In embodiments hafnium is present in a range of from 0.2 to 0.7 wt %. Alternatively, hafnium is present in an amount of from 0.4 to 0.6 wt %. Preferably, hafnium is present in an amount of from 0.45 to 0.55 wt % (e.g. 0.5 wt %).

Vanadium is present as a carbide former and solid solution strengthener. In embodiments vanadium is present in a range of from 0.1 to 0.4 wt %. Alternatively, vanadium is present in an amount of from 0.2 to 0.3 wt %. Preferably, vanadium is present in an amount of from 0.245 to 0.255 wt % (e.g. 0.25 wt %).

Hafnium and vanadium are usually not present together in the alloys of the invention, unless one appears only as an incidental impurity. Thus, the alloys contain either 0.1 to 1.0 wt % hafnium or 0.1 to 1.0 wt % vanadium.

In embodiments, in order to provide effective solid solution strengthening elements, Mo (5 wt. %) and Nb (2.2 wt. %) were added in the recited amounts.

In embodiments Al was added in an amount of 6.6 wt. % to increase the gamma prime fraction. Al₂O₃ is also recognised as being a more effective protective oxide layer at higher temperatures than Cr₂O₃, accordingly in embodiments Cr is present in 12.5 wt. % to keep the Nv down. Mo was present in 4.0 wt. % and W was present in 0.5 wt. %.

In embodiments of the invention the alloy further comprises iron and/or magnesium. Magnesium is preferably present in the alloy of the invention in an amount of from 0.0002 to 0.008 wt %. Iron is either absent or present in an amount of from 0.4 to 1.2 wt %, 0.3 to 0.7 wt %, or 0.8 to 1.2 wt % optionally 1.0 wt % or 0.5 wt %.

The alloys of the invention inevitably contain other trace elements in addition to the deliberately added elements referred to above. These trace elements either have no effect on the technical properties of the alloys or, in some cases, have a small adverse effect on the alloys. However, given the relatively small levels in which these additional elements appear in the alloys they can be regarded as incidental impurities. These incidental elements include nitrogen, oxygen, sulphur and phosphorus. Oxygen forms oxides which are stress raisers and cause cracking. Nitrogen causes cracking and porosity thorough the formation of nitrides. Sulphur works against the beneficial stress rupture effects of components of the alloy by being a grain boundary embrittler. Sulphur also causes spallation of the protective oxide layer, reducing high temperature oxidation and corrosion resistance. Sulphur also reduces hot oxidation resistance. Phosphorus is also a grain boundary embrittler. The relatively low levels of one or more of these elements when present does not significantly affect the properties of the alloys.

In some cases the alloy of the invention may have a maximum concentration of 50 ppm oxygen. Separately alloy may have a maximum concentration of 50 ppm nitrogen. The alloy may also independently have a maximum concentration of 100 ppm sulphur. Similarly, the alloy may also independently have a maximum concentration of 100 ppm phosphorus. The skilled person will understand when and in what quantities these elements might occur and be tolerated depending on the source of the component elements in the alloy.

Certain metals may also be present in the alloys of the invention as incidental impurities. For example, iron may be present as a trace component in one or more of the main component elements and thus may find its way into the final alloys of the invention. However, iron is not deliberately added and it has no observed technical effect on the properties of the alloy at the low levels at which it may be present. Iron, when present, may occur in an amount of up to 1.5% wt, though usually the level is 1.0% wt or less, and in some cases it is possible to exclude iron completely.

Another incidental impurity that can be present in the alloy of the present invention is silicon. Silicon can be present in an amount up to 0.15 wt % or up to 0.10 wt %. For example, silicon may be present in an amount of up to 0.05 wt %.

The alloy of the present invention may sometimes contain a small amount of magnesium as an incidental impurity depending on the source of the main elemental components. Magnesium, when present, is usually present in such small amounts that it does not appear to have any technical effect in its own right and so it can be considered as an incidental impurity. In some cases, the alloy of the invention includes up to 0.008 wt % of magnesium as an incidental impurity.

In certain cases, magnesium may have the beneficial effect of reacting with any sulphur that might be present. If so, this can contribute to improving the grain bonding ductility.

Copper is another metal which in low quantities does not affect the alloy of the invention. Thus, when present, copper can be tolerated in an amount of up to at least 0.02 wt % without any observable effect on the properties of the alloy. Copper can be regarded as an incidental element.

Certain components of the alloy of the invention are specified as being optionally present. As the skilled person would appreciate, where a component of the alloy is optionally present the component is either present or absent. A component that is absent for the purposes of imparting a technical effect might still be present as an incidental impurity rather than a deliberately added element. In such a case, the element will not have any technical effect.

In accordance with the present inventions there is provided a nickel alloy. The nickel alloy comprises:

from 0.01 to 0.3 wt % carbon,
from 7.0 to 15.0 wt % chromium
optionally from 8 to 12.0 wt % cobalt,
from 3.0 to 7.0 wt % molybdenum,
from 0.1 to 9.5 wt % tungsten,
from 1.0 to 3.0 wt % niobium,
optionally from 0.5 to 1.5 wt % tantalum,
from 0.5 to 2.0 wt % titanium,
from 3.5 to 7.0 wt % aluminium,
from 0 to 3.0 wt % boron,
from 0.01 to 0.1 wt % zirconium; and
either from 0.1 to 1.0 wt % hafnium or from 0.1 to 1.0 wt % vanadium,
with the balance of the composition being nickel and incidental impurities.

In preferred embodiments the nickel alloy of the invention consists of:

from 0.7 to 0.13 wt % carbon,
from 12.3 wt % to 12.7 wt % chromium
cobalt is absent,
from 3.8 to 4.2 wt % molybdenum,
from 0.3 to 0.7 wt % tungsten,
from 1.8 to 2.2 wt % niobium,
tantalum is absent,
from 0.6 to 1.0 wt % titanium,
from 6.4 to 6.8 wt % aluminium,
from 0.01 to 0.02 wt % boron,
from 0.05 to 0.07 wt % zirconium; and
from 0.2 to 0.3 wt % vanadium,
with the balance of the composition being nickel and incidental impurities.

In preferred embodiments the nickel alloy of the invention consists of:

from 0.13 to 0.19 wt % carbon,
from 8.05 to 8.35 wt % chromium
from 9.8 to 10.2 wt % cobalt,
from 4.8 to 5.2 wt % molybdenum,
from 6.8 to 7.2 wt % tungsten,
from 2.0 to 2.4 wt % niobium,
from 0.6 to 1.0 wt % tantalum,
from 0.8 to 1.2 wt % titanium,
from 5.3 to 5.7 wt % aluminium,
from 0.01 to 0.02 wt % boron,
from 0.04 to 0.06 wt % zirconium; and
from 0.4 to 0.6 wt % hafnium,
with the balance of the composition being nickel and incidental impurities.

In an embodiment the nickel alloy consists of:

0.1 wt % carbon
12.5 wt % chromium,
4.0 wt % molybdenum,
0.5 wt % tungsten,
2.0 wt % niobium,
0.8 wt % titanium,
6.6 wt % aluminium,
0.01 wt % boron,
0.06 wt % zirconium; and
0.25 wt % vanadium,
with the balance of the composition being nickel and incidental impurities.

In an embodiment the nickel alloy consists of:

0.1 wt % carbon
12.5 wt % chromium,
4.0 wt % molybdenum,
0.5 wt % tungsten,
2.0 wt % niobium,
0.8 wt % titanium,
6.6 wt % aluminium,
0.01 wt % boron,
0.06 wt % zirconium,
from 0.0002 to 0.008 wt % of magnesium;
optionally 1.0 wt % iron; and
0.25 wt % vanadium,
with the balance of the composition being nickel and incidental impurities.

A nickel alloy of claim 1, the alloy consisting of:

0.16 wt % carbon
8.2 wt % chromium,
10 wt % cobalt
5.0 wt % molybdenum,
7.0 wt % tungsten,
2.2 wt % niobium,
0.8 wt % tantalum
1.0 wt % titanium,
5.5 wt % aluminium,
0.015 wt % boron,
0.05 wt % zirconium; and
0.5 wt % hafnium,
with the balance of the composition being nickel and incidental impurities.

A nickel alloy of claim 1, the alloy consisting of:

0.16 wt % carbon
8.2 wt % chromium,
10 wt % cobalt
5.0 wt % molybdenum,
7.0 wt % tungsten,
2.2 wt % niobium,
0.8 wt % tantalum
1.0 wt % titanium,
5.5 wt % aluminium,
0.015 wt % boron,
0.05 wt % zirconium,
from 0.0002 to 0.008 wt % of magnesium;
optionally 0.5 wt % iron; and
0.5 wt % hafnium,
with the balance of the composition being nickel and incidental impurities.

### BRIEF DESCRIPTION OF THE DRAWINGS

FIG. 1 shows the results of simulations to predict the high temperature strength of Examples 1 and 2 and the Reference alloys 1 and 2.

FIGS. 2 to 4 shows the results simulations to predict the high temperature rupture life of Examples 1 and 2 and the Reference alloys 1 and 2 at 3 different temperatures.

FIG. 5 is a representation of a typical manufacturing process.

### DETAILED DESCRIPTION

Alloys according to the present invention are produced in a VIM furnace under vacuum or protective Argon atmosphere. The first stage of preparing the alloy involves calculating the relative proportions by weight of the various elemental components and scrap or masteralloys (which are the source of the various elements required in the final alloy) in order to achieve the desired amounts of the various elements which are required in the final alloy. The solid masteralloys, scrap or elements are added to the furnace. Heating is applied in order to melt all of the components together and ensure a thorough mixing of the components in the furnace so that the elements are properly distributed within the matrix.

Masteralloys, scrap or elements used in the process are commercially available.

Once melting and mixing has been achieved gaseous and low boiling point impurities are removed by exposure to the vacuum and non-metallics are removed by floatation, leaving a clean bath of liquid alloy in the furnace. A sample of the molten alloy is then removed from the furnace, allowed to cool and analysed by spectroscopic or other accepted analytical methods in order to determine its elemental composition. An adjustment to the composition may or may not be required at this stage to accommodate for any elemental mass loss during melting. The composition is adjusted by the addition of further elements as necessary, and optionally re-analysed to ensure that the desired composition has been achieved.

After the desired composition has been achieved, the temperature is further raised above the melting temperature to a tapping temperature in order to ensure easy pouring of the melt into moulds of the desired size and shape.

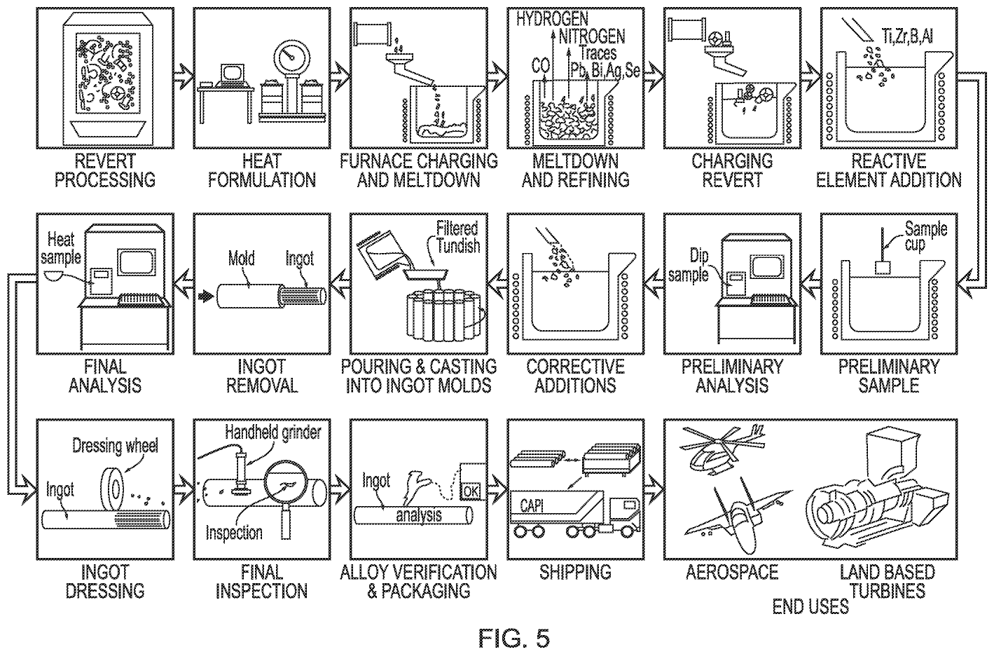

FIG. 5 is a representation of a typical manufacturing process.

### EXAMPLES

Two example alloys have been manufactured. The composition of the alloys are disclosed below.

Example 1 is a nickel alloy having the composition shown below:

0.16 wt % carbon
8.2 wt % chromium,
10 wt % cobalt
5.0 wt % molybdenum,
7.0 wt % tungsten,
2.2 wt % niobium,
0.8 wt % tantalum
1.0 wt % titanium,
5.5 wt % aluminium,
0.015 wt % boron,
0.05 wt % zirconium,
0.5 wt % hafnium,
with the balance of the composition being nickel and incidental impurities.

Example 2 is a nickel alloy having the composition shown below:

0.1 wt % carbon
12.5 wt % chromium,
4.0 wt % molybdenum,
0.5 wt % tungsten,
2.0 wt % niobium,
0.8 wt % titanium,
6.6 wt % aluminium,
0.01 wt % boron,
0.06 wt % zirconium,
0.25 wt % vanadium,
with the balance of the composition being nickel and incidental impurities.

Test pieces of Examples 1 and 2 were melted in a small R&D VIM furnace and were cast into test carrots, using the investment casting process. The test carrots are being machined into tensile and stress rupture test pieces. Test pieces have been produced for Examples 1 and 2. Test carrots of two known alloys have been formed, Reference Example 1 (commercially available alloy Mar-M247) and Reference Example 2 (commercially available alloy IN7130). The performance of the test carrots of Examples 1 and 2 and the test carrots of Reference Example 1 (Mar-M247) and Reference Example 2 (IN7130) will be compared in a range of mechanical tests. The mechanical tests are set out below. It is anticipated that the performance of Examples 1 and 2 will be improved over the known alloys. This is due to the beneficial properties of Examples 1 and 2 demonstrated in predictive software.

Mechanical Testing

High temperature tensile testing—samples from each alloy will be tested at room temperature, 850° C., 950° C. and 1050° C. This is an industry standard test.

High temperature stress rupture testing—samples from each alloy will be tested at 850° C., 950° C. and 1050° C. This is also an industry standard test.

High temperature oxidation and corrosion testing—samples of each of the alloys will be exposed to exhaust gases from and diesel exhaust engines at elevated temperatures (850° C., 950° C. and 1050° C.) for extended periods. This test is designed to closely replicate the operating environment of turbocharger turbine wheels, although the samples will be not be subjected to any stress during the testing. This test will enable the high temperature oxidation and corrosion resistance to be determined for each alloy.

Metallography—samples of each alloy will be exposed to high temperatures (850° C., 950° C. and 1050° C.) for extended periods. Samples will be withdrawn at periodic intervals to be prepared for metallographic evaluation. This test will enable the high temperature microstructural evolution of each alloy to be determined.

### Example 3

The high temperature properties of alloys of Examples 1 and 2 were modelled using the commercial computer programme JMatPro. Properties of the alloys along with Mar-M247 and IN713C were generated in JMatPro.

### Example 3a—High Temperature Tensile Properties

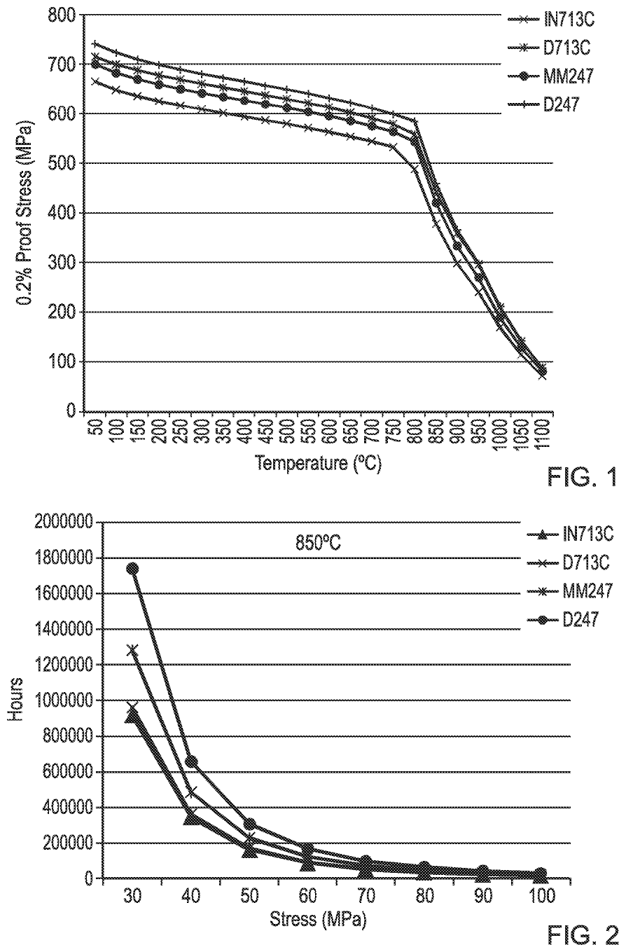

FIG. 1 shows the results of the simulations using JMatPro to predict the high temperature strength of Examples 1 and 2 and the Reference alloys 1 and 2. Example 1 showed a higher high temperature strength than that of Reference Example 1. It was unexpected that the performance of Example 1 would be better than that of Reference Example 1.

The simulations also showed that Example 2 exceeded the higher temperature mechanical properties of Reference Example 2. In addition Example 2 was shown to exceed the properties of Reference Example 1 at high temperature, an alloy which is four times the cost of example 1.

### Example 3b—High Temperature Rupture Life

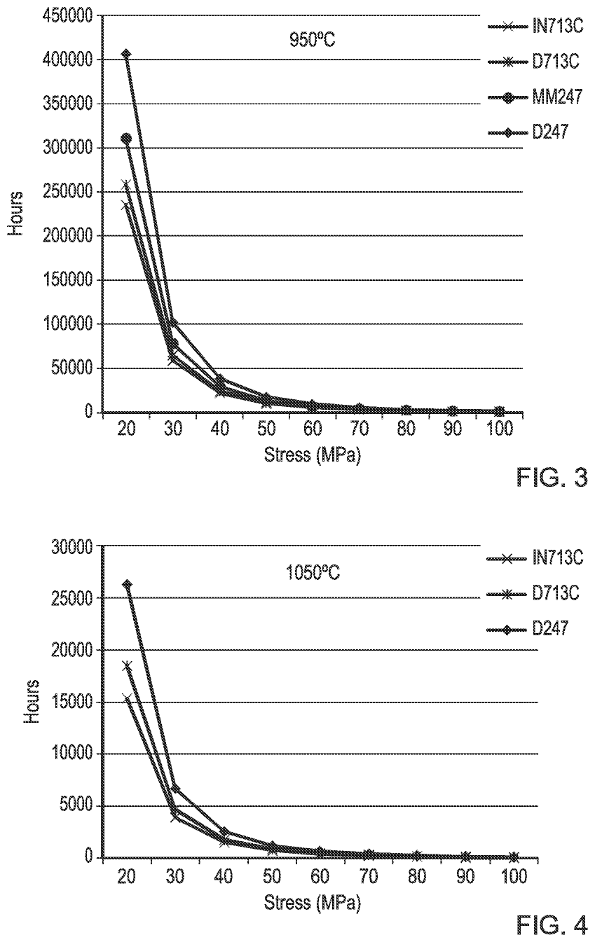

Data generated using JMatPro indicates that the rupture life of Example 1 is greater than that of Reference Example 1 and that of Example 2 is greater than that of Reference Example 2 at elevated temperatures, as shown in FIGS. 2-4.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A nickel alloy comprising or consisting of:
from 0.01 to 0.3 wt % carbon,
from 7.0 to 15.0 wt % chromium
from 0 to 12.0 wt % cobalt,
from 3.0 to 7.0 wt % molybdenum,
from 0.1 to 9.5 wt % tungsten,
from 1.0 to 3.0 wt % niobium,
from 0 to 2.0 wt % tantalum,
from 0.5 to 2.0 wt % titanium,
from 3.5 to 7.0 wt % aluminium,
from 0 to 3.0 wt % boron,
from 0.01 to 0.1 wt % zirconium; and
either from 0.1 to 1.0 wt % hafnium or from 0.1 to 1.0 wt % vanadium, with the balance of the composition being nickel and incidental impurities.

2. A nickel alloy of claim 1 wherein carbon is present in a range of from 0.05 to 0.2 wt %.

3. A nickel alloy of claim 1, wherein chromium is present in a range of from 7.5 to 13 wt %.

4. A nickel alloy of claim 1, wherein molybdenum is present in a range of from 3.5 to 5.5 wt %.

5. A nickel alloy of claim 1, wherein niobium is present in a range of from 1.8 to 2.5 wt %.

6. A nickel alloy of claim 1, wherein titanium is present in a range of from 0.6 to 1.2 wt %.

7. A nickel alloy of claim 1, wherein aluminium is present in a range of from 5.0 to 7.0 wt %.

8. A nickel alloy of claim 1, wherein boron is present in a range of from 0.005 to 0.02 wt %.

9. A nickel alloy of claim 1, wherein zirconium is present in a range of from 0.03 to 0.08 wt %.

10. A nickel alloy of claim 1, wherein hafnium is present in a range of from 0.2 to 0.7 wt %.

11. A nickel alloy of claim 1, wherein vanadium is present in a range of from 0.1 to 0.4 wt %.

12. A nickel alloy of claim 1, wherein cobalt is optionally present in a range of from 9 to 11 wt %.

13. A nickel alloy of claim 1, wherein tantalum is optionally present in a range of from 0.5 to 1 wt %.

14. A nickel alloy of claim 1, wherein tungsten is present in a range of 0.1 to 1.0 wt % or 5 to 9 wt %.

15. A nickel alloy of claim 1, wherein the iron is present in an amount of 0.5 or 1 wt %.

16. A nickel alloy of claim 1, the alloy comprising:
0.1 wt % carbon
12.5 wt % chromium,
4.0 wt % molybdenum,
0.5 wt % tungsten,
2.0 wt % niobium,
0.8 wt % titanium,
6.6 wt % aluminium,
0.01 wt % boron,
0.06 wt % zirconium; and
0.25 wt % vanadium,
with the balance of the composition being nickel and incidental impurities.

17. A nickel alloy of claim 1, the alloy comprising:
0.16 wt % carbon
8.2 wt % chromium,
10 wt % cobalt
5.0 wt % molybdenum,
7.0 wt % tungsten,
2.2 wt % niobium,
0.8 wt % tantalum
1.0 wt % titanium,
5.5 wt % aluminium,
0.015 wt % boron,
0.05 wt % zirconium; and
0.5 wt % hafnium,
with the balance of the composition being nickel and incidental impurities.

18. A nickel alloy of claim 1, wherein tungsten is present in a range 5 to 9 wt %.
